(19) United States
(12) Patent Application Publication
(10) Pub. No.: US 2026/0080420 A1
(43) Pub. Date: Mar. 19, 2026

(54) VARIABLE ANTI-COUNTERFEITING METHOD, SYSTEM, DEVICE AND MEDIUM FOR A PRODUCT SALES TERMINAL

(71) Applicant: Foshan Yuhe Technology Co., Ltd., Foshan (CN)

(72) Inventor: Fuquan DENG, Foshan (CN)

(21) Appl. No.: 19/399,749

(22) Filed: Nov. 25, 2025

Related U.S. Application Data
(63) Continuation of application No. PCT/CN2025/122919, filed on Sep. 22, 2025.

(30) Foreign Application Priority Data
Jul. 23, 2024 (CN) 202410989762.2

(51) Int. Cl. G06Q 30/018

(52) U.S. Cl. CPC G06Q 30/0185

(57) ABSTRACT

A variable anti-counterfeiting method, system, device and medium for a product sales terminal include: identifying, by a detection terminal, a detected terminal and enabling the tested terminal to access a cloud platform, and identifying, by the cloud platform, a manner in which a current detection terminal accesses the cloud platform; discriminating, by the cloud platform, the password according to a preset comparison rule; when the cloud platform discriminates the password to be correct, changing the password according to a preset change rule, granting the current detection terminal ordinary view access to product information and exclusive view access to a changed password, and simultaneously incorporating the detected terminal into a warehousing system associated with the current detection terminal; when the cloud platform discriminates the password to be incorrect, sending a counterfeit alert message to the current detection terminal.

### CROSS-REFERENCE TO RELATED APPLICATION

This application is a continuation of PCT application serial no. PCT/CN2025/122919, filed on Sep. 22, 2025, which claims the priority and benefit of Chinese patent application serial no. 202410989762.2, filed on Jul. 23, 2024. The entireties of PCT application serial no. PCT/CN2025/122919 and Chinese patent application serial no. 202410989762.2 are hereby incorporated by reference herein and made a part of this specification.

### TECHNICAL FIELD

The present application relates to the technical field of anti-counterfeiting, and in particular, to a variable anti-counterfeiting method, system, device and medium for a product sales terminal.

### BACKGROUND ART

In a domestic market, counterfeit and substandard goods are rampant, their quality and safety often cannot be guaranteed, posing serious economic, social and safety risks. Such products are widely present in various industries, including food, pharmaceuticals, electronic products and clothing, etc., and their proliferation not only damages legitimate rights and interests of consumers but also brings negative impacts to an entire market.

Currently, there exist various anti-counterfeiting technologies in the market, such as a QR code anti-counterfeiting and a RFID anti-counterfeiting, etc. By scanning labels or codes on products, the consumers can verify authenticity of the products. Taking the QR code anti-counterfeiting as an example, a coating is applied over the QR codes of the products for anti-counterfeiting purposes; after scraping off the coating, a mobile terminal scans the QR code to obtain anti-counterfeiting data, then sends the anti-counterfeiting data to a server, the server converts the data and compares same with its corresponding product database; upon successful verification, the server returns a verification result to the mobile terminal, thereby achieving anti-counterfeiting.

The above-mentioned anti-counterfeiting code verification mechanism is relatively single, resulting in limited anti-counterfeiting effectiveness when the products are resold multiple times or when anti-counterfeiting codes are illegally copied.

Therefore, researching a variable anti-counterfeiting method for a product sales terminal is of significant importance.

### SUMMARY

An objective of the present application is to provide a variable anti-counterfeiting method, system, device and medium for a product sales terminal, which features improved anti-counterfeiting effectiveness in product sales terminal scenarios.

In a first aspect, the present application provides a variable anti-counterfeiting method for a product sales terminal, which adopts the following technical solution:

A variable anti-counterfeiting method for a product sales terminal includes:
connecting a current detection terminal to a cloud platform by identifying a detected terminal, where the cloud platform identifies a manner in which the current detection terminal is connected to the cloud platform, comprising: when the current detection terminal is connected to the cloud platform without identifying the detected terminal through a preset system, the cloud platform sends a verification program to the current detection terminal, the current detection terminal sends a first password to the cloud platform for verification, wherein the first password is provided by a previous seller, the cloud platform discriminates the first password according to a preset comparison rule, when the cloud platform discriminates the first password to be correct, the cloud platform changes the first password according to a preset change rule, grants the current detection terminal the ordinary view access to the product information and exclusive view access to the changed first password, and simultaneously incorporates the detected terminal into a warehousing system associated with the current detection terminal, and when the cloud platform discriminates the first password to be incorrect, the cloud platform sends counterfeit alert message to the current detection terminal;
detecting by the cloud platform whether the detected terminal is bound to the current detection terminal, when the current detection terminal is connected to the cloud platform with identifying the detected terminal by the preset system;
sending a second password and the verification program to the current detection terminal, when the cloud platform detects that the detected terminal is not bound to a detection terminal, binding the detected terminal to the current detection terminal after successful verification, granting the current detection terminal the ordinary view access to the product information, and notifying the current detection terminal that the product is genuine;
determining whether the bound detection terminal is the current detection terminal, when the cloud platform detects that the detected terminal is bound to the detection terminal;
granting the current detection terminal the view access to the product information, when the cloud platform detects that the bound detection terminal is the current detection terminal; and
sending the counterfeit alert message to the current detection terminal, when the cloud platform detects that the bound detection terminal is not the current detection terminal.

Optionally, the identifying, by the detection terminal, the detected terminal and enabling the detected terminal to access the cloud platform, and identifying, by the cloud platform, a manner in which a current detection terminal accesses the cloud platform further includes:
when the detection terminal accesses the cloud platform without identifying the detected terminal through a preset system, sending, by the cloud platform, a verification program to the current detection terminal;
sending, by the current detection terminal, a password to the cloud platform for verification, wherein the password is provided by a previous seller;
discriminating, by the cloud platform, the password according to a preset comparison rule;
when the cloud platform discriminates the password to be correct, changing the password according to the preset change rule, and opening ordinary viewing permission for product information and exclusive viewing permission for a changed password to the current detection terminal; and
when the cloud platform discriminates the password to be incorrect, sending counterfeit alert message to the current detection terminal.

Optionally, the detecting, by the cloud platform, whether the detected terminal is bound to the detection terminal, when the detection terminal accesses the detected terminal to the cloud platform through the preset system further includes:
sending the password and the verification program to the current detection terminal, when the cloud platform detects that the detected terminal is not bound to the detection terminal, binding the detected terminal to the current detection terminal after successful verification, and simultaneously, changing, by the cloud platform, the password according to the preset change rule, and opening the ordinary viewing permission for the product information and the exclusive viewing permission for the changed password to the current detection terminal;
judging whether the bound detection terminal is the current detection terminal, when the cloud platform detects that the detected terminal is bound to the detection terminal;
opening the ordinary viewing permission for the product information and the exclusive viewing permission for the changed password to the current detection terminal, when the cloud platform detects that the bound detection terminal is the current detection terminal;
sending the counterfeit alert message and the verification program to the current detection terminal, when the cloud platform detects that the bound detection terminal is not the current detection terminal, opening the ordinary viewing permission for the product information to the current detection terminal, when the cloud platform receives the changed password and successfully verifying the changed password.

Optionally, the discriminating, by the cloud platform, the password according to the preset comparison rule includes:
making verification information of the detected terminal further comprises a password storage address number of the detected terminal, retrieving, by the cloud platform, a reference code based on the password storage address number of the detected terminal and comparing the password with the reference code;
determining the password to be correct when the password is consistent with the reference code; and
determining the password to be incorrect when the password is inconsistent with the reference code.

Optionally, the changing the password according to the preset change rule includes:
automatically triggering a password generation system to generate encrypted data when the cloud platform discriminates the password to be correct, setting the encrypted data as the changed password, and synchronizing a corresponding reference code;
the step of generating the encrypted data by the password generation system includes randomly generating a UUID as an encryption data source, and using an MD5 encryption algorithm to encrypt the data source to obtain the encrypted data.

Optionally, the detected terminal includes a package detected terminal and a product detected terminal; when the cloud platform performs an operation on the package detected terminal, the cloud platform synchronously operates product detected terminals within the package;
wherein, synchronously changing the passwords of the product detected terminals within the package, when the cloud platform changes the password of the package detected terminal;
synchronously binding the current detection terminal with the product detected terminals within the package, when the cloud platform binds the current detection terminal with the package detected terminal;
synchronously opening, by the cloud platform, the exclusive viewing permission of the passwords of the product detected terminals within the package to the current detection terminal, when the cloud platform opens the exclusive viewing permission of the password of the package detected terminal to the current detection terminal; and
synchronously opening, by the cloud platform, the ordinary viewing permission for the commodities of the product detected terminals within the package to the current detection terminal, when the cloud platform opens the ordinary viewing permission of the password of the package detected terminal to the current detection terminal.

Optionally, the sending, by the cloud platform, the verification program to the current detection terminal further includes:
simultaneously acquiring, by the cloud platform, an ID code of the current detection terminal, when the cloud platform sends the verification program to the current detection terminal to obtain the password; associating the ID code of the current detection terminal with the changed password, when the password is correct and replaced, and registering the association between the ID code of the current detection terminal and the changed password in a traceability table; and
matching, by the cloud platform, the incorrect password with the passwords in the traceability table, when the password is incorrect; registering the ID code of the current detection terminal into an exception record table corresponding to the successfully matched password, when the match is successful; marking the password in the traceability table as being in an abnormal state, when a number in the exception record table reaches a preset threshold, and triggering the cloud platform to send an infringement alert message and an abnormal data package to the production terminal, wherein the abnormal data package comprises the password in the abnormal state and the ID code of the associated detection terminal.

In a second aspect, the present application provides a variable anti-counterfeiting system for a product sales terminal, which includes a detection terminal and a cloud platform;
the detection terminal including an access module and a sending module;
the cloud platform includes an identification module, a verification module, a comparison module, a changing module and a notification module;
wherein, the detection terminal accesses the cloud platform through the access module by identifying the detected terminal, and the cloud platform identifies a manner in which the current detection terminal access the cloud platform through the identification module;
sending, by the cloud platform, a verification program to the current detection terminal through the verification module, when the detection terminal directly detects and accesses the cloud platform through the detected terminal;
sending, by the current detection terminal, the password to the cloud platform through the sending module for verification, wherein the password is provided by a previous seller;
discriminating, by the cloud platform, the password according to a preset comparison rule through the comparison module;

when the cloud platform discriminates the password to be correct, changing, by the changing module, the password according to a preset change rule, and opening ordinary viewing permission for product information and exclusive viewing permission for a changed password to the current detection terminal; and
sending, by the notification module, counterfeit alert message to the current detection terminal, when the cloud platform discriminates the password to be incorrect.

In a third aspect, the present application provides an electronic device including a memory, a processor, and a computer program stored in the memory and operable on the processor, wherein the processor executes the computer program to implement the steps of the variable anti-counterfeiting method for the product sales terminal described above.

In a fourth aspect, the present application provides a non-transitory computer storage medium storing a computer program, wherein the computer program is executed by a processor to implement the steps of the variable anti-counterfeiting method for a product sales terminal described above.

In conclusion, the present application includes the following beneficial technical effects:
in the scenario of the product sales terminal, by identifying the detected terminal through the preset system to access the cloud platform, the cloud platform detects whether the detected terminal is bound to the detection terminal, when not, the cloud platform binds the detection terminal with the detected terminal, this operation is irreversible, and no unbinding is possible after binding, when counterfeit products exist, users at the sales terminal can scan the code through the preset system to identify that the product has counterfeiting suspicion. Moreover, in the present application, the cloud platform is configured to send the password to the current detection terminal, which can effectively enhance flexibility of sales, reducing inconvenience for sales personnel needing to query the system to inform the users of the password, and at the same time facilitating a binding operation.

### BRIEF DESCRIPTION OF THE DRAWINGS

FIG. 1 is a schematic flow diagram of a variable anti-counterfeiting method for a product sales terminal according to a first embodiment of the present application.

FIG. 2 is a schematic flow diagram of additional steps added to step S0 according to a second embodiment of the present application.

FIG. 3 is a schematic flow diagram of additional steps added to step S1 according to the second embodiment of the present application.

FIG. 4 is a schematic flow diagram of specific steps of step S22 according to the second embodiment of the present application.

FIG. 5 is a schematic flow diagram of additional steps added to a step of a cloud platform sending a verification program to a current detection terminal according to the second embodiment of the present application.

FIG. 6 is a schematic structure diagram of a variable anti-counterfeiting system for the product sales terminal according to the first embodiment of the present application.

FIG. 7 is a principle block diagram of an electronic device according to the first embodiment of the present application.

### DETAILED DESCRIPTION

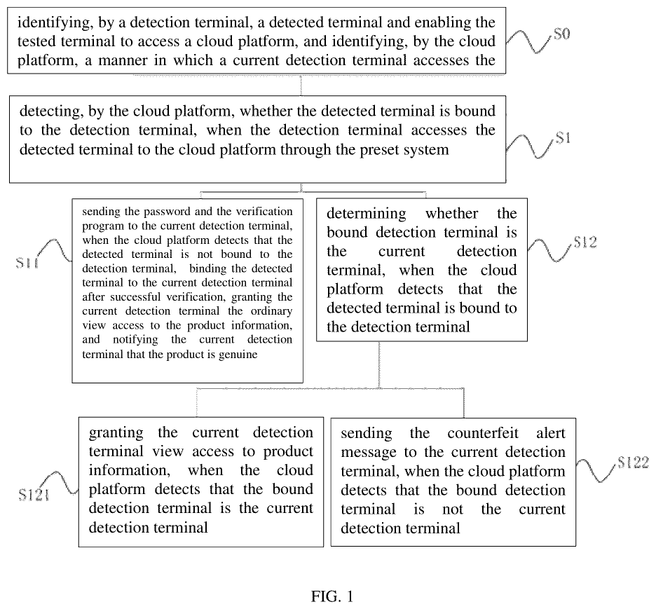

The present application will be further described in detail below referring to FIGS. 1-7.

In order to make the objectives, technical solutions and advantages of the present application more clear and understandable, the present application is further described in detail below with reference to FIGS. 1-7 and the embodiments. It should be understood that the specific embodiments described herein are only used to explain the present application, and are not used to limit the present application.

The present application provides a variable anti-counterfeiting method, system, device and medium for a product sales terminal.

Referring to FIG. 1, the variable anti-counterfeiting method for the product sales terminal disclosed in one embodiment of the present application includes:
S0. identifying, by a detection terminal, a detected terminal and enabling the tested terminal to access a cloud platform, and identifying, by the cloud platform, a manner in which a current detection terminal accesses the cloud platform.

Wherein, in one embodiment, the detected terminal may be a chip, and the detection terminal may be a detection instrument provided on a supporting product side of a manufacturer or a mobile phone equipped with an NFC function; in another embodiment, the detected terminal may be a graphic code such as a two-dimensional code (QR code) or a barcode, and the detection terminal may be a commonly used internet communication equipment such as a mobile phone. Identification between the detection terminal and the detected terminal includes at least a plurality of methods such as numbers, symbols, letters, images, and frequency bands. The cloud platform allows the detection terminal to access by means of identifying the detected terminal, in order to distinguish between a product transportation process scenario and a product sales terminal scenario, the cloud platform in the present application needs to identify how the detection terminal accesses the cloud platform. Wherein, anti-counterfeiting objects in the product transportation process are mainly distributors, wholesalers, and retailers. The cloud platform system belongs to research and management of the manufacturer, and the manufacturer is the production terminal, thus, the manufacturer has full viewing and management permissions over all content in the cloud platform. Simultaneously, the cloud platform also sets up a corresponding warehousing system for the distributors, the wholesalers, and the retailers, which is conductive to management during the product transportation process and also facilitates users to view product information after purchasing the product, including sales times, and locations of the manufacturers, the distributors, the wholesalers, and the retailers involved in a sales chain, as well as query counts, query times, and query locations of the product.

In addition, the detected terminal set in the present application includes two types: package and products. One package contains a plurality of products, the package is provided with a package detected terminal, and each of the plurality of products is provided with a product detected terminal, wherein, during the product transportation process, the detection terminal primarily identifies the package detected terminal, but can also identify the product detected terminal. Since the distributors, the wholesalers, and the retailers typically purchase in bulk, setting up the package detected terminal facilitates product warehousing and anti-counterfeiting management. However, there may also be a case where the packages is split for individual product purchases.

S1. Detecting, by the cloud platform, whether the detected terminal is bound to the detection terminal, when the detection terminal accesses the detected terminal to the cloud platform through the preset system.

S11. Sending the password and the verification program to the current detection terminal, when the cloud platform detects that the detected terminal is not bound to the detection terminal, binding the detected terminal to the current detection terminal after successful verification, granting the current detection terminal the ordinary view access the product information, and notifying the current detection terminal that the product is genuine.

S12 determining whether the bound detection terminal is the current detection terminal, when the cloud platform detects that the detected terminal is bound to the detection terminal.

S121. granting the current detection terminal a view access to the product information, when the cloud platform detects that the bound detection terminal is the current detection terminal.

S122. Sending the counterfeit alert message to the current detection terminal, when the cloud platform detects that the bound detection terminal is not the current detection terminal.

As mentioned above, in the scenario of the product sales terminal, when the users purchase the product and conduct anti-counterfeiting authentication, they need to use a preset system, which can be selected as a mini program or an official website, by identifying the detected terminal through the preset system to access the cloud platform, the cloud platform detects whether the detected terminal is bound to the detection terminal, when not, the cloud platform binds the detection terminal with the detected terminal, this operation is irreversible, and no unbinding is possible after binding. When counterfeit products exist, the users at the sales terminal can scan the code through the preset system to identify that the product has counterfeiting suspicion. Moreover, in the present application, the cloud platform is configured to send the password to the current detection terminal, which can effectively enhance flexibility of sales, reducing inconvenience for sales personnel needing to query the system to inform the users of the password, and at the same time facilitating a binding operation.

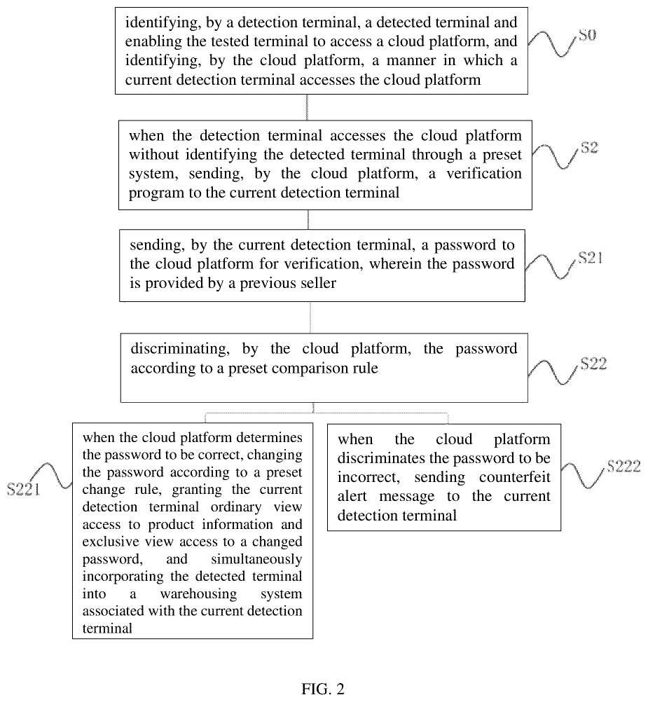

Further, referring to FIG. 2, in another embodiment, step S0: identifying, by the detection terminal, the detected terminal and enabling the tested terminal to access the cloud platform, and identifying, by the cloud platform, the manner in which the current detection terminal accesses the cloud platform further includes the following steps:
S2 When the detection terminal accesses the cloud platform without identifying the detected terminal through the preset system, sending, by the cloud platform, the verification program to the current detection terminal.

Wherein, when the detection terminal accesses the cloud platform without identifying the detected terminal through the preset system, that is, without using a specific mini-program or an official website, the detection terminal directly identifies the detected terminal via a mobile NFC recognition chip or by scanning the QR code, triggering the cloud platform to send a verification code to the current detection terminal, the set verification program is configured for the cloud platform to receive the password from the detection terminal.

In another embodiment, after the cloud platform identifies the above access method, in addition to sending the verification program, it also triggers activation of the warehousing system, which is configured to enable the distributors, the wholesalers, and the retailers to manage the product warehousing, and also facilitating later batch viewing of the product information and the password.

S21. Send, by the current detection terminal, the password to the cloud platform for verification, wherein the password is provided by a previous seller.

S22. Discriminate, by the cloud platform, the password according to a preset comparison rule.

As mentioned above, when the verification program is triggered, the current detection terminal needs to input the password provided by the previous seller into the verification program. The cloud platform discriminates whether the password is correct.

S221. When the cloud platform discriminates the password to be correct, changing the password according to a preset change rule, granting the current detection terminal the ordinary view access to the product information and exclusive view access to the changed password, and simultaneously incorporating the detected terminal into the warehousing system associated with the current detection terminal.

Wherein, the ordinary viewing permission means that once granted by the cloud platform, the users permanently retains the right to view; whereas the exclusive viewing permission means that only the seller of the current detection terminal can view except for the manufacturer, and all previous sellers have no viewing rights.

S222. When the cloud platform discriminates the password to be incorrect, sending the counterfeit alert message to the current detection terminal.

As mentioned above, during the product transportation process, since the password changes after the product or the package is correctly identified once, when the counterfeit products or counterfeit packages exist, since the genuine detected terminal has already been authenticated by a counterfeiter, and when the counterfeiter does not know the password will change, mass-produces counterfeits of the detected terminal of one product or package will only result in password identification errors, allowing the next distributor to receive the counterfeit alert message. When the counterfeiter knows the password will change and informs the next distributor of the password, that password can only be correctly identified once. When the distributor detects a second counterfeit product, the password has already changed, and the distributor still receives the counterfeit alert message. By immediately changing the password upon successful verification and setting the exclusive viewing permission for the changed password, anti-counterfeiting effect during product transportation is effectively enhanced.

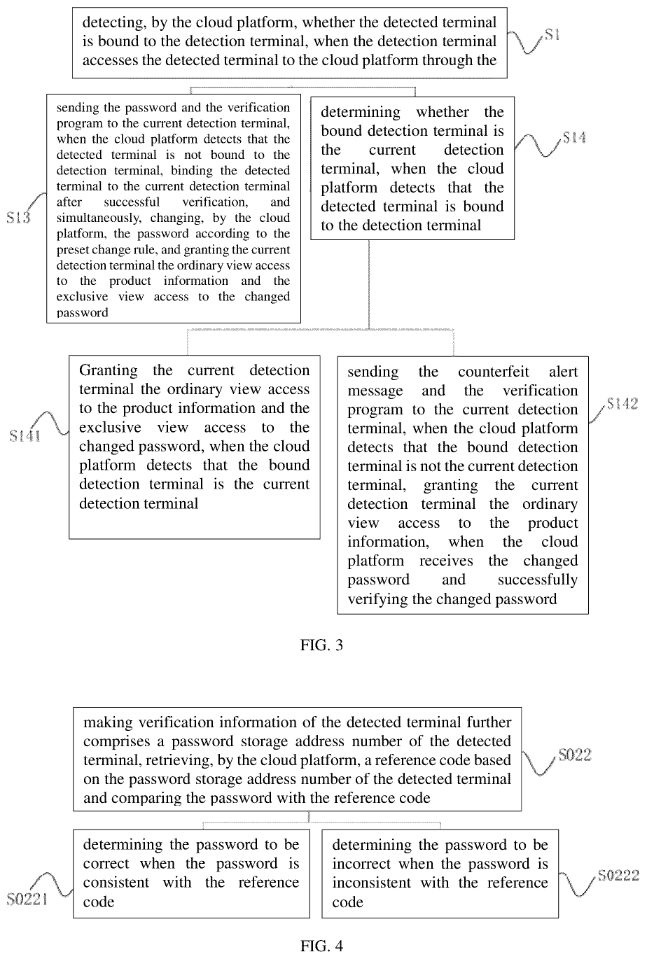

Further, referring to FIG. 3, in another embodiment, step S1: detecting, by the cloud platform, whether the detected terminal is bound to the detection terminal, when the detection terminal accesses the detected terminal to the cloud platform through the preset system further includes the following steps:
S13. sending the password and the verification program to the current detection terminal, when the cloud platform detects that the detected terminal is not bound to the detection terminal, binding the detected terminal to the current detection terminal after successful verification, and simultaneously, changing, by the cloud platform, the password according to the preset change rule, and granting the current detection terminal the ordinary view access to the product information and the exclusive view access the changed password.
S14. Determining whether the bound detection terminal is the current detection terminal, when the cloud platform detects that the detected terminal is bound to the detection terminal.
S141. Granting the current detection terminal the ordinary view access to the product information and the exclusive view access to the changed password, when the cloud platform detects that the bound detection terminal is the current detection terminal.
S142. Sending the counterfeit alert message and the verification program to the current detection terminal, when the cloud platform detects that the bound detection terminal is not the current detection terminal, granting the current detection terminal the ordinary view access to the product information, when the cloud platform receives the changed password and successfully verifying the changed password.

As mentioned above, after completing the binding operation, the password is also changed simultaneously, so that other users can view the product information as long as they are informed of the changed password. Although other users will receive the counterfeit alert message indicating “the product has been purchased or used and has counterfeiting suspicion”, as long as the password is correct, the ordinary view access to the product information is granted to the current detection terminal. This setting is conductive to improving the flexibility of the product in use after purchase.

Additionally, in the present application, the detected terminal includes the package detected terminal and the product detected terminal, when the cloud platform performs an operation on the package detected terminal, the cloud platform synchronously operates all product detected terminals within the package.

Specifically, when the cloud platform changes the password of the package detected terminal, it synchronously changes the passwords of all the product detected terminals within the package; when the cloud platform binds the current detection terminal with the package detected terminal, it synchronously binds the current detection terminal with all the product detected terminals within the package; when the cloud platform grants the current detection terminal the exclusive view access to the password of the package tested terminal, it synchronously grants the current detection terminal the exclusive view access to the passwords of all the product detected terminals within the package; when the cloud platform grants the current detection terminal the ordinary view access to the password of the package detected terminal, it synchronously grants the current detection terminal the ordinary view access to all the product detected terminals within the package.

As mentioned above, synchronously changing the passwords of all the product detected terminals within the package when the cloud platform changes the password of the package detected terminal, and synchronously granting the current detection terminal exclusive view access to the passwords of all the product detected terminals within the package when the cloud platform grants the current detection terminal exclusive view access of the password of the package detected terminal, which is set to ensure that the previous seller does not know either the password of the package detected terminal or the password of the product detected terminal after successful product verification. This further improves anti-counterfeiting during the product transportation process. Compared with a situation where the passwords of the product detected terminal are not synchronized, it also reduces incidents in the sales chain where the previous sellers, knowing the password of the product detected terminal, stealing or replacing genuine products for resale. When the cloud platform binds the current detection terminal with the package detected terminal, it simultaneously binds the current detection terminal with all the product detected terminals within the package, reducing a binding workload when end users purchase in large quantities. When the cloud platform grants the current detection terminal ordinary view access to the password of the package detected terminal, it synchronously grants the current detection terminal ordinary view access to the commodities of all the product detected terminals within the package; and when the cloud platform grants the current detection terminal the exclusive view access to the password of the package detected terminal, it synchronously grants the current detection terminal the exclusive view access to the passwords of all the product detected terminals within the package, which is conductive to simplifying a process of anti-counterfeit authentication and the warehousing for the distributors, reducing their workload, improving work efficiency during the product transportation process, and making product sales management more flexible.

Further, referring to FIG. 4, in another embodiment, step S22: discriminating, by the cloud platform, the password according to the preset comparison rule, which specifically includes the following steps:
S022. making verification information of the detected terminal further comprises a password storage address number of the detected terminal, retrieving, by the cloud platform, a reference code based on the password storage address number of the detected terminal and comparing the password with the reference code.
S0221. Determining the password to be correct when the password is consistent with the reference code.
S0222. Determining the password to be incorrect when the password is inconsistent with the reference code.

As mentioned above, the method of retrieving based on the password storage address number of the detected terminal can improve a retrieval speed.

Further, in another embodiment, step S221: changing the password according to the preset change rule specifically includes the following steps: automatically triggering a password generation system to generate encrypted data when the cloud platform discriminates the password to be correct, setting the encrypted data as the changed password, and synchronizing a corresponding reference code. The step of generating the encrypted data by the password generation system includes randomly generating a UUID as an encryption data source, and using an MD5 encryption algorithm to encrypt the data source to obtain the encrypted data.

As mentioned above, the UUID generates unique identifiers, ensuring data source uniqueness, while adding encryption algorithms ensures data confidentiality and integrity. When the detected terminal is of a QR code type, the cloud platform directly sets the corresponding reference code as the encrypted data. When the detected terminal is of a chip type, the encrypted data is injected into the chip upon successful verification, and the corresponding reference code is replaced with the encrypted data.

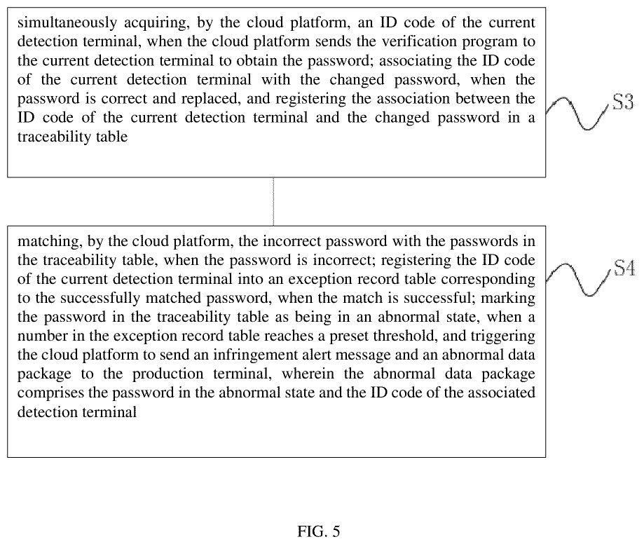

Further, referring to FIG. 5, in another embodiment, the step of sending, by the cloud platform, the verification program to the current detection terminal further includes:
S3. simultaneously acquiring, by the cloud platform, an ID code of the current detection terminal, when the cloud platform sends the verification program to the current detection terminal to obtain the password; associating the ID code of the current detection terminal with the changed password, when the password is correct and replaced, and registering the association between the ID code of the current detection terminal and the changed password in a traceability table;
S4. matching, by the cloud platform, the incorrect password with the passwords in the traceability table, when the password is incorrect; registering the ID code of the current detection terminal into an exception record table corresponding to the successfully matched password, when the match is successful; marking the password in the traceability table as being in an abnormal state, when a number in the exception record table reaches a preset threshold, and triggering the cloud platform to send an infringement alert message and an abnormal data package to the production terminal, wherein the abnormal data package comprises the password in the abnormal state and the ID code of the associated detection terminal.

As mentioned above, by establishing the traceability table, the detected terminals that are widely counterfeited can be promptly identified. Furthermore, since the ID of the corresponding detection terminal is bound, the manufacturers can trace the counterfeit products back to owners of problematic detection terminals, promptly uncover counterfeiting activities, specifically assign liability for counterfeit to individual nodes, and thereby enhancing product security.

It should be understood that the size of the sequence numbers of the steps in the above embodiments is not meant to imply a sequence of carrying out these steps which should be determined by their function and inherent logic, and should not be construed as limiting the implementation of the embodiments of the present application in any way.

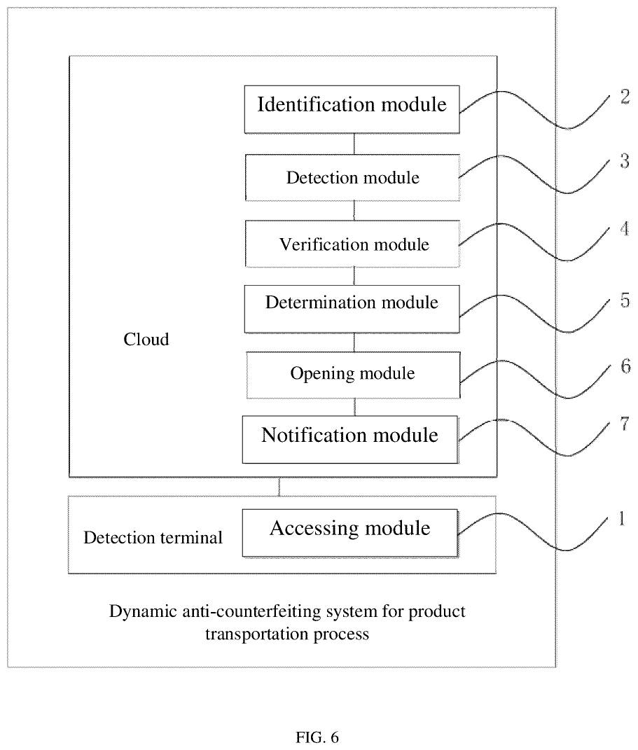

The present application further provides a variable anti-counterfeiting system for a product sales terminal, which corresponds one-to-one with the variable anti-counterfeiting method for the product sales terminal described in the embodiments. Referring to FIG. 6, the variable anti-counterfeiting system for the product sales terminal includes: a detection terminal and a cloud platform; the detection terminal includes an access module 1; the cloud platform includes an identification module 2, a detection module 3, a verification module 4, a determination module 5, an access grant module 6, and a notification module 7.

Each functional module is described in detail as follows:
wherein, the detection terminal accesses the cloud platform through the access module 1 by identifying the detected terminal, and the cloud platform identifies a manner in which the current detection terminal access the cloud platform through the identification module 2; detecting, by the cloud platform, whether the detected terminal is bound to the detection terminal through the detection module 3, when the detection terminal accesses the detected terminal to the cloud platform through the preset system; sending, by the verification module, the password and the verification program to the current detection terminal, when the cloud platform detects that the detected terminal is not bound to the detection terminal, binding the tested terminal to the current detection terminal, after successful verification, granting the current detection terminal the ordinary view access to the product information; when the cloud platform detects that the detected terminal is bound to the detection terminal, the determination module 5 determines whether the bound detection terminal is the current detection terminal; when the cloud platform detects that the bound detection terminal is the current detection terminal, the access grant module 6 grants the current detection terminal the view access to the product information; when the cloud platform detects that the bound detection terminal is not the current detection terminal, the notification module 7 sends the counterfeit alert message to the current detection terminal.

Specific limitations regarding the dynamic anti-counterfeiting system for the product sales terminal can be found in the context of the dynamic anti-counterfeiting method for the product sales terminal, and details will not be repeated here. The modules in the above-mentioned dynamic anti-counterfeiting system for the product sales terminal may be entirely or partially implemented through software, hardware, or a combination thereof. The modules may be embedded in the hardware or separate from the processor in the electronic device, or may be stored in the software in a memory in the electronic device, such that the processor invokes operations corresponding to the modules.

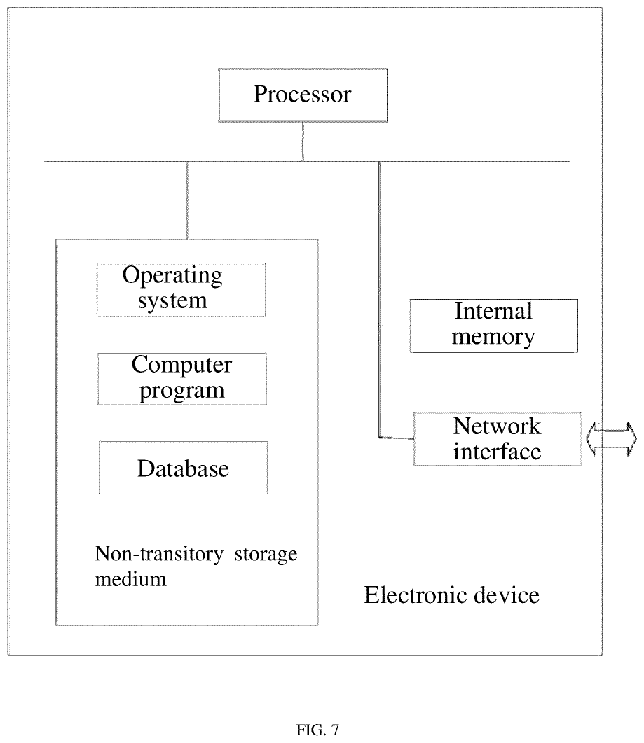

In the present embodiment, an electronic device is provided, which is a computer. Referring to FIG. 7, the electronic device includes a processor, a memory, a network interface, and a database connected by a system bus. Wherein, the processor of the electronic device is configured to provide computing and control capabilities. The memory of the electronic device includes a non-transitory storage medium, and an internal memory. The non-transitory storage medium stores an operating system, a computer program, and a database. The internal memory provides an environment for an operation of the operating system and computer program in the non-transitory storage medium. The database of the electronic device is configured to store detection data tables. The network interface of the electronic device is configured to communicate with an external terminal via a network connection. When executed by the processor, the computer program implements a dynamic anti-counterfeiting method for the product sales terminal.

In one embodiment, an electronic device is provided, including a memory, a processor, and a computer program stored on the memory and executable by the processor, wherein the processor executes the computer program to implement the steps described in the above-mentioned method embodiments.

The embodiment of the present application further discloses a non-transitory computer-readable storage medium storing a computer program capable of being loaded and executed by a processor, when executed by the processor, the computer program implements the steps of any one of the above-mentioned dynamic anti-counterfeiting methods for the product sales terminal, and achieves the same effect.

Wherein, Examples of such computer-readable storage media include: an U-disk, a removable hard disk, a Read-Only Memory (ROM), a Random Access Memory (RAM), a magnetic or an optical disk, and other media capable of storing program code.

The above are all preferred embodiments of the present application and are not intended to limit the protection scope of the present application thereby; any feature disclosed in this specification (including the abstract and the drawings), unless specifically stated, may be replaced by other equivalent alternative features or alternative features serving a similar purpose. That is, unless specifically stated, each feature is merely an example of a series of equivalent or similar features.

### LIST OF REFERENCE SIGNS

1. access module;
2. identification module;
3. detection module;
4. verification module;
5. determination module;
6. access grant module;
7. notification module.

What is claimed is:

1. A variable anti-counterfeiting method for a product sales terminal, comprising:
connecting a current detection terminal to a cloud platform by identifying a detected terminal, wherein the cloud platform identifies a manner in which the current detection terminal is connected to the cloud platform, comprising: when the current detection terminal is connected to the cloud platform without identifying the detected terminal through a preset system, the cloud platform sends a verification program to the current detection terminal, the current detection terminal sends a first password to the cloud platform for verification, wherein the first password is provided by a previous seller, the cloud platform discriminates the first password according to a preset comparison rule, when the cloud platform discriminates the first password to be correct, the cloud platform changes the first password according to a preset change rule to obtain a changed first password, grants the current detection terminal ordinary view access to product information and exclusive view access to the changed first password, and simultaneously incorporates the detected terminal into a warehousing system associated with the current detection terminal, and when the cloud platform discriminates the first password to be incorrect, the cloud platform sends counterfeit alert message to the current detection terminal;
detecting by the cloud platform whether the detected terminal is bound to a detection terminal, when the detection terminal is connected to the cloud platform with identifying the detected terminal by the preset system;
sending a second password and the verification program to the current detection terminal, when the cloud platform detects that the detected terminal is not bound to a detection terminal, binding the detected terminal to the current detection terminal after successful verification, granting the current detection terminal the ordinary view access to the product information, and notifying the current detection terminal that a product is genuine;
determining whether the detection terminal bound to the detected terminal is the current detection terminal, when the cloud platform detects that the detected terminal is bound to the detection terminal;
granting the current detection terminal the ordinary view access to the product information, when the cloud platform detects that the bound detection terminal is the current detection terminal; and
sending the counterfeit alert message to the current detection terminal, when the cloud platform detects that the bound detection terminal is not the current detection terminal.

2. The method according to claim 1, wherein detecting by the cloud platform whether the detected terminal is bound to the current detection terminal when the current detection terminal is connected to the cloud platform with identifying the detected terminal by the preset system further comprises:
sending the second password and the verification program to the current detection terminal, when the cloud platform detects that the detected terminal is not bound to the detection terminal, binding the detected terminal to the current detection terminal after successful verification, simultaneously, changing by the cloud platform the second password according to the preset change rule to obtain a changed second password, granting by the cloud platform the current detection terminal the ordinary view access to the product information and the exclusive view access to the changed second password;
determining whether the bound detection terminal is the current detection terminal, when the cloud platform detects that the detected terminal is bound to the detection terminal;
granting the current detection terminal the ordinary view access to the product information and the exclusive view access to the changed second password, when the cloud platform detects that the bound detection terminal is the current detection terminal; and
sending the counterfeit alert message and the verification program to the current detection terminal, when the cloud platform detects that the bound detection terminal is not the current detection terminal, and granting the current detection terminal the ordinary view access to the product information when the cloud platform receives the changed second password and successfully verifies the changed second password.

3. The method according to claim 1, wherein a step of discriminating the first password according to the preset comparison rule by the cloud platform comprises:
retrieving a reference code based on a password storage address number of the detected terminal and comparing the first password with the reference code by the cloud platform, the password storage address number of the detected terminal is contained in verification information of the detected terminal;
determining the first password to be correct when the first password is consistent with the reference code; and
determining the first password to be incorrect when the first password is inconsistent with the reference code.

4. The method according to claim 3, wherein a step of changing the first password according to the preset change rule comprises:
automatically triggering a password generation system to generate encrypted data when the cloud platform discriminates the first password to be correct, setting the encrypted data as the changed first password, and synchronizing the reference code;
a step of generating the encrypted data by the password generation system comprises randomly generating a Universally Unique Identifier (UUID) as a data source for encryption, and using an MD5 encryption algorithm to encrypt the data source to obtain the encrypted data.

5. The method according to claim 1, wherein the detected terminal comprises a package detected terminal and a product detected terminal, when the cloud platform performs an operation on the package detected terminal, the cloud platform synchronously performs an operation on product detected terminals within the package;
when the cloud platform changes the first password of the package detected terminal, the cloud platform synchronously changes first passwords of the product detected terminals within the package;
when the cloud platform binds the current detection terminal with the package detected terminal, the cloud platform synchronously binds the current detection terminal with the product detected terminals within the package;
when the cloud platform grants the current detection terminal the exclusive view access to the first password of the package detected terminal, the cloud platform synchronously grants the current detection terminal the exclusive view access to the first passwords of the product detected terminals within the package; and
when the cloud platform grants the current detection terminal the ordinary view access to the first password of the package detected terminal, the cloud platform synchronously grants the current detection terminal the ordinary view access to commodities of the product detected terminals within the package.

6. The method according to claim 1, wherein a step of sending the verification program to the current detection terminal by the cloud platform further comprises:
acquiring an identification (ID) code of the current detection terminal by the cloud platform while sending the verification program by the cloud platform to the current detection terminal to obtain the first password, associating the ID code of the current detection terminal with the changed first password when the first password is correct and replaced, and registering an associated relationship between the ID code of the current detection terminal and the changed first password in a traceability table; and
matching, when the first password is incorrect, the first password with first passwords in the traceability table by the cloud platform, when the matching is successful, the ID code of the current detection terminal is registered in an exception record table corresponding to the first password, when a number in the exception record table reaches a preset threshold, the first password in the traceability table is marked as abnormal and the cloud platform is triggered to send an infringement alert message and an abnormal data package to a production terminal, and the abnormal data package comprises the first password and the ID code of an associated detection terminal.

7. A variable anti-counterfeiting system for a product sales terminal, comprising a detection terminal and a cloud platform,
wherein the detection terminal comprises an access module,
the cloud platform comprises an identification module, a detection module, a verification module, a determination module, an access grant module, and a notification module;
the detection terminal is connected to the cloud platform through the access module by identifying a detected terminal, the cloud platform identifies a manner in which a current detection terminal is connected to the cloud platform, comprising: when the current detection terminal is connected to the cloud platform without identifying the detected terminal through a preset system, the cloud platform sends a verification program to the current detection terminal, the current detection terminal sends a first password to the cloud platform for verification, wherein the first password is provided by a previous seller, the cloud platform discriminates the first password according to a preset comparison rule, when the cloud platform discriminates the first password to be correct, the cloud platform changes the first password according to a preset change rule to obtain a changed first password, grants the current detection terminal ordinary view access to product information and exclusive view access to the changed first password, and simultaneously incorporates the detected terminal into a warehousing system associated with the current detection terminal, and when the cloud platform discriminates the first password to be incorrect, the cloud platform sends counterfeit alert message to the current detection terminal,
the cloud platform detects whether the detected terminal is bound to a detection terminal, when the detection terminal is connected to the cloud platform with identifying the detected terminal by the preset system,
when the cloud platform detects that the detected terminal is not bound to a detection terminal, a second password and the verification program are sent to the current detection terminal by the verification module, the detected terminal is bound to the current detection terminal after successful verification, and the current detection terminal is granted the ordinary view access to the product information;
the determination module determines whether the detection terminal bound to the detected terminal is the current detection terminal when the cloud platform detects that the detected terminal is bound to the detection terminal;
the current detection terminal is granted the ordinary view access to the product information by the access grant module, when the cloud platform detects that the bound detection terminal is the current detection terminal; and
the notification module sends a counterfeit alert message to the current detection terminal, when the cloud platform detects that the bound detection terminal is not the current detection terminal.

8. An electronic device, comprising a memory and a processor, wherein the memory stores a computer program capable of being loaded and executed by the processor to implement the variable anti-counterfeiting method for a product sales terminal according to claim 1.
